(19) United States
(12) Patent Application Publication
(10) Pub. No.: US 2024/0186061 A1
(43) Pub. Date: Jun. 6, 2024

(54) COIL COMPONENT

(71) Applicant: SAMSUNG ELECTRO-MECHANICS CO., LTD., Suwon-si (KR)

(72) Inventors: Han LEE, Suwon-si (KR); Boum Seock KIM, Suwon-si (KR)

(73) Assignee: SAMSUNG ELECTRO-MECHANICS CO., LTD., Suwon-si (KR)

(21) Appl. No.: 18/386,739

(22) Filed: Nov. 3, 2023

(30) Foreign Application Priority Data
Dec. 2, 2022 (KR) 10-2022-0166776

(51) Int. Cl. H01F 27/30; H01F 5/04; H01F 27/29

(52) U.S. Cl. CPC H01F 27/306; H01F 5/04; H01F 27/292

(57) ABSTRACT

A coil component includes a body, a support member disposed in the body, a first coil disposed on one surface of the support member, a second coil disposed on the other surface of the support member, a plurality of conductive vias connecting the first coil to the second coil, a first external electrode disposed on the body and connected to one end of the first coil, and a second external electrode disposed on the body and connected to one end of the second coil, wherein the first coil includes a plurality of first pads connected to the plurality of conductive vias and a first connection portion disposed between the plurality of first pads, and a line width of at least one of the plurality of first pads is greater than a line width of the first connection portion.

### CROSS-REFERENCE TO RELATED APPLICATION (S)

This application claims benefit of priority to Korean Patent Application No. 10-2022-0166776 filed on Dec. 2, 2022 in the Korean Intellectual Property Office, the disclosure of which is incorporated herein by reference in its entirety.

### BACKGROUND

### 1. Technical Field

The present disclosure relates to a coil component.

### 2. Description of the Related Art

With the reduction of a size and a thickness of an electronic device such as a digital TV, a mobile phone, and a laptop, a coil component applied to the electronic device may also need to have a reduced size and thickness. To meet these demands, research and development of various wound-type coil components or thin film-type coil components have been conducted.

A major issue due to reduction of a size and thickness of a coil component may be to implement properties equivalent to those of a generally used coil component despite the reduction. To satisfy these demands, it may be necessary to increase a ratio of magnetic material in a core filled with a magnetic material, but there may be a limitation in increasing the ratio due to strength of an inductor body and changes in frequency properties according to insulation.

### SUMMARY

An aspect of the present disclosure is to provide a coil component having improved electrical properties. Another aspect of the present disclosure is to provide a coil component which may be advantageous for miniaturization and may have excellent properties by securing sufficient size of a core.

According to an aspect of the present disclosure, a coil component includes a body, a support member disposed in the body, a first coil disposed on one surface of the support member, a second coil disposed on the other surface of the support member, a plurality of conductive vias connecting the first coil to the second coil, a first external electrode disposed on the body and connected to one end of the first coil, and a second external electrode disposed on the body and connected to one end of the second coil, wherein the first coil includes a plurality of first pads connected to the plurality of conductive vias and a first connection portion disposed between the plurality of first pads, and a line width of at least one of the plurality of first pads is greater than a line width of the first connection portion.

In the first coil, an external turn adjacent to the first connection portion may have a line width greater than a line width of the first connection portion.

An external turn adjacent to the plurality of first pads in the first coil may have a line width greater than a line width of the plurality of first pads.

The second coil may include a plurality of second pads connected to the plurality of conductive vias and a second connection portion disposed between the plurality of second pads, and a line width of at least one of the plurality of second pads may be greater than a line width of the second connection portion.

In the second coil, an external turn adjacent to the second connection portion may have a line width greater than a line width of the second connection portion.

In the second coil, an external turn adjacent to the plurality of second pads may have a line width greater than a line width of the plurality of first pads.

One of the plurality of conductive vias may be connected to the other end of the first coil, and at least one other via among the plurality of conductive vias may be connected to the other end of the second coil.

The first coil may include: (i) a plurality of first pad regions respectively including a plurality of first pads, and (ii) a first connection region connecting the plurality of first pad regions to each other.

The first connection region may have a line width greater than a line width of the plurality of first pads.

One of the plurality of first pad regions may include the other end of the first coil.

One of the plurality of first pads may be connected to the first connection region.

The second coil may include: (i) a plurality of second pad regions respectively including a plurality of second pads, and (ii) a second connection region connecting the plurality of second pad regions to each other.

The coil component may further include a dummy pattern disposed on the other surface of the support member, spaced apart from the second coil and connected to the first coil through the plurality of conductive vias.

The plurality of conductive vias may include three or more conductive vias.

The first coil may have an innermost turn including: (i) a first end portion that may include the other end of the first coil, and (ii) a second end portion directly connected to an external turn of the first coil. No pads may be disposed on the second end portion.

The innermost turn may further include a middle portion between the first and second end portions, and the first pads may be disposed in the middle portion and the first end portion.

The first pads in the middle portion may face the first pads in the first end portion.

The first pads may be disposed only in the first end portion.

### BRIEF DESCRIPTION OF DRAWINGS

The above and other aspects, features, and advantages of the present disclosure will be more clearly understood from the detailed description, in following taken conjunction with the accompanying lead-outs, in which:

FIG. 1 is a perspective diagram illustrating a coil component according to an embodiment of the present disclosure;

FIG. 2 is an exploded diagram illustrating a portion of components of the coil component illustrated in FIG. 1;

FIG. 3 is a plan diagram illustrating a first coil in the coil component illustrated in FIG. 1;

FIG. 4 is a plan diagram illustrating a second coil in the coil component illustrated in FIG. 1; and

FIGS. 5 to 7 are diagrams illustrating a coil component according to a modified embodiment of the present disclosure.

### DETAILED DESCRIPTION

Hereinafter, embodiments of the present disclosure will be described as follows with reference to the attached drawings.

The present disclosure may, however, be exemplified in many different forms and should not be construed as being limited to the specific embodiments set forth herein. Rather, these embodiments are provided such that this disclosure will be thorough and complete, and will fully convey the scope of the disclosure to those skilled in the art. Accordingly, shapes and sizes of the elements in the drawings may be exaggerated for clarity of description. Also, elements having the same function in the scope of the same concept represented in the drawing of each embodiment will be described using the same reference numeral.

Various types of electronic components may be used in electronic devices, and various types of coil components may be appropriately used between these electronic components for the purpose of removing noise. That is, in an electronic device, a coil component may be used as a power inductor, a HF inductor, a general bead, a GHz bead, a common mode filter, or the like.

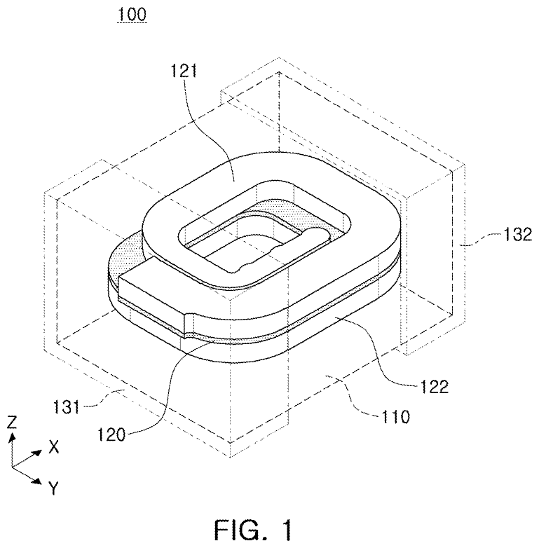

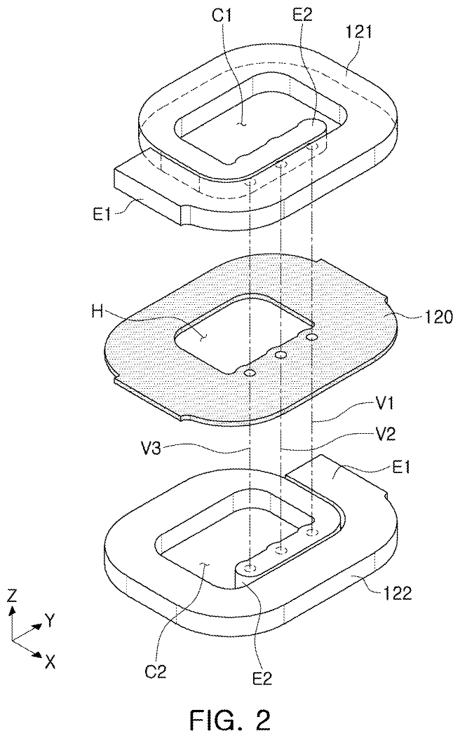

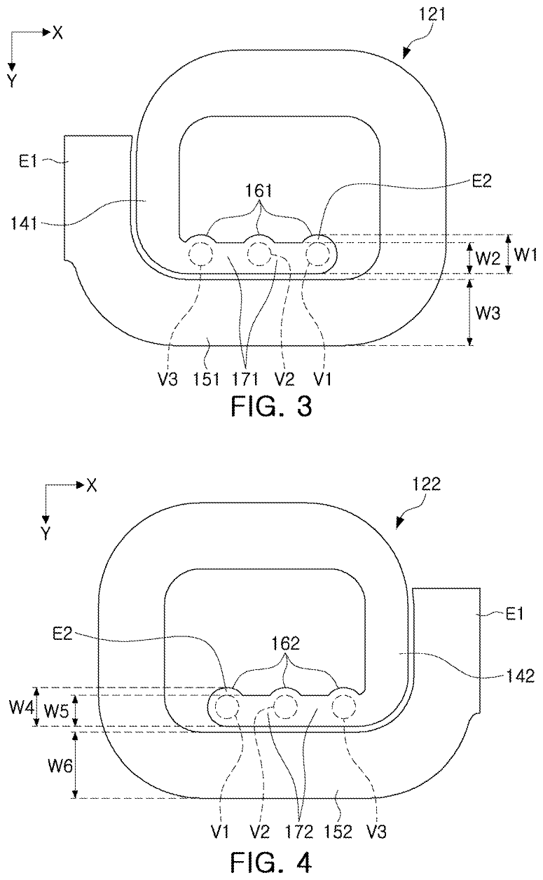

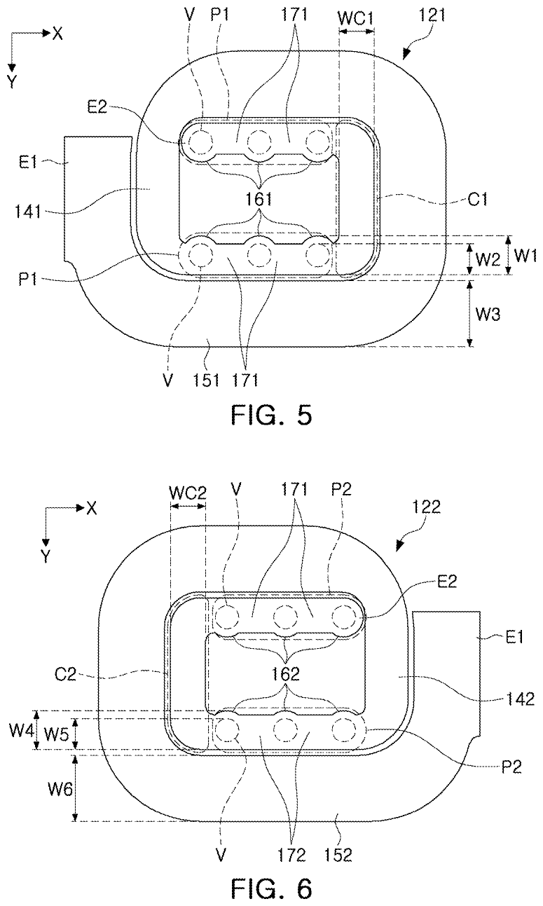

FIG. 1 is a perspective diagram illustrating a coil component according to an embodiment. FIG. 2 is an exploded diagram illustrating a portion of components of the coil component illustrated in FIG. 1. FIG. 3 is a plan diagram illustrating a first coil in the coil component illustrated in FIG. 1. FIG. 4 is a plan diagram illustrating a second coil in the coil component illustrated in FIG. 1.

Referring to FIGS. 1 to 4, a coil component 100 according to an embodiment may include a body 110, a support member 120, a first coil 121, a second coil 122, a plurality of conductive vias V1, V2, and V3, a first external electrode 131, and a second external electrode 132. Here, the first coil 121 may include a plurality of first pads 161 connected to the plurality of conductive vias V1, V2, and V3 and a first connection portion 171 disposed therebetween, and a line width W1 of at least one of the plurality of first pads 161 may be greater than a line width W2 of the first connection portion 171. Since the first coil 121 is connected to the plurality of conductive vias V1, V2, and V3, structural and electrical connectivity of the first and second coils 121 and 122 may be improved. Furthermore, as the line width W2 of the first connection portion 171 connecting the plurality of first pads 161 to each other is relatively reduced, the sizes of the cores C1 and C2 may be sufficiently secured such that magnetic properties (e.g., Ls and Iₛₐₜ properties) of the coil component 100 may also be improved. In this case, similarly to the first coil 121, the second coil 122 may include a plurality of second pads 162 connected to the plurality of conductive vias V1, V2, and V3 and a second connection portion 172 disposed therebetween, and a line width W4 of at least one of the plurality of second pads 162 may be greater than a line width W5 of the second connection portion 172. Hereinafter, main components included in the coil component 100 in an embodiment will be described.

The body 110 may form an exterior of the coil component 100, and coils 121 and 122 and a support member 120 may be disposed therein. As illustrated, the body 110 may be formed in a hexahedral shape. As an example, in the body 110, the coil component 100 according to an embodiment in which the external electrodes 131 and 132 are formed may have a length of 2.5 mm, a width of 2.0 mm and a thickness of 1.0 mm, or a length of 2.0 mm, a width of 1.2 mm and a thickness of 0.65 mm, or a length of 1.6 mm, a width of 0.8 mm and a thickness of 0.8 mm, or a length of 1.0 mm, a width of 0.5 mm and a thickness of 0.5 mm, or a length of 0.8 mm, a width of 0.4 mm and a thickness of 0.65 mm, but an embodiment thereof is not limited thereto. Since the above-described numerical values are merely design values not reflecting process errors, etc., the range recognized as a process error may belong to the range in an embodiment.

The length of the coil component 100 in the first direction (X-direction) may be a maximum value of each dimension of a plurality of line segments connecting the two outermost boundary lines opposing each other in the first direction (X-direction) of the coil component 100 illustrated in the cross-sectional image and parallel to the first direction (X-direction) with respect to an optical microscope or scanning electron microscope (SEM) image of a cross-section in the first direction (X-direction)-third direction (Z-direction) in central portion of coil component 100 in the second direction (Y-direction), a minimum value of dimensions of each of a plurality of line segments connecting the two outermost boundary lines opposing each other in the first direction (X-direction) of the coil component 100 illustrated in the cross-sectional image and parallel to the first direction (X-direction), or an arithmetic mean of at least three of dimensions of each of a plurality of line segments connecting the two outermost boundary lines opposing each other in the first direction (X-direction) of the coil component 100 illustrated in the cross-sectional image and parallel to the first direction (X-direction). Here, the plurality of line segments parallel to the first direction (X-direction) may be equally spaced apart from each other in the third direction (Z-direction), but an embodiment thereof is not limited thereto.

The length of the coil component 100 in the second direction (Y-direction) may be a maximum value of each dimension of a plurality of line segments connecting the two outermost boundary lines opposing each other in the second direction of (Y-direction) the coil component 100 illustrated in the cross-sectional image and parallel to the second direction (Y-direction) with respect to an optical microscope or scanning electron microscope (SEM) image of a cross-section in the first direction (X-direction)-second direction (Y-direction) in a central portion of coil component 100 in the third direction (Z-direction), a maximum value of each dimension of a plurality of line segments connecting the two outermost boundary lines opposing each other in the second direction (Y-direction) of the coil component 100 illustrated in the cross-sectional image and parallel to the second direction (Y-direction), a minimum value of each dimension of a plurality of line segments parallel to the second direction (Y-direction) connecting the two outermost boundary lines opposing each other in the second direction (Y-direction) of the coil component 100 illustrated in the cross-sectional image, or an arithmetic mean of at least three of dimensions of each of a plurality of line segments connecting the two outermost boundary lines opposing each other in the second direction (Y-direction) of the coil component 100 illustrated in the cross-sectional image and parallel to the second direction (Y-direction). Here, the plurality of line segments parallel to the second direction (Y-direction) may be equally spaced apart from each other in the first direction (X-direction), but an embodiment thereof is not limited thereto.

The length in the third direction (Z-direction) of the coil component 100 described above may be a maximum value of dimensions of each of the plurality of line segments connecting the two outermost boundary lines opposing each other in the third direction (Z-direction) of the coil component 100 illustrated in the cross-sectional image and parallel to the third direction (Z-direction) with respect to an optical microscope or scanning electron microscope (SEM) image of a cross-section in the first direction (X-direction)-third direction (Z-direction) in a central portion of coil component 100 in the second direction (Y-direction), a minimum value among dimensions of each of the plurality of line segments connecting the two outermost boundary lines opposing each other in the third direction (Z-direction) of the coil component 100 illustrated in the cross-sectional image and parallel to the third direction (Z-direction), or an arithmetic mean of at least three of dimensions of each of a plurality of line segments connecting the two outermost boundary lines opposing each other in the third direction (Z-direction) of the coil component 100 illustrated in the cross-sectional image and parallel to the third direction (Z-direction). Here, the plurality of line segments parallel to the third direction (Z-direction) may be equally spaced apart from each other in the first direction (X-direction), but an embodiment thereof is not limited thereto.

Each of the lengths of the first to third directions of the coil component 100 may be measured by a micrometer measurement method. The micrometer measurement method may be to measure by setting a zero point with a micrometer with Gage R&R (repeatability and reproducibility), inserting a coil component 100 according to an embodiment between tips of the micrometer, and turning the measuring lever of the micrometer. In measuring the length of the coil component 100 by the micrometer measurement method, the length of the coil component 100 may refer to a value measured once or may refer to an arithmetic average of values measured multiple times.

The body 110 may include an insulating resin and a magnetic material. Specifically, the body 110 may be formed by laminating one or more magnetic composite sheets in which a magnetic material is dispersed in an insulating resin. The magnetic material may be ferrite or metallic magnetic powder. Ferrite may be at least one of, for example, spinel-type ferrite such as Mg—Zn-based ferrite, Mn—Zn-based ferrite, Mn—Mg-based ferrite, Cu—Zn-based ferrite, Mg—Mn—Sr-based ferrite, Ni—Zn-based ferrite, hexagonal ferrites such as Ba—Zn-based ferrite, Ba—Mg-based ferrite, Ba—Ni-based ferrite, Ba—Co-based ferrite, Ba—Ni—Co-based ferrite, garnet-type ferrites such as Y-based ferrite, and Li-based ferrites. Metal magnetic powder may include one or more selected from a group consisting of iron (Fe), silicon (Si), chromium (Cr), cobalt (Co), molybdenum (Mo), aluminum (Al), niobium (Nb), copper (Cu) and nickel (Ni). For example, the magnetic metal powder may be at least one of pure iron powder, Fe—Si alloy powder, Fe—Si—Al alloy powder, Fe—Ni alloy powder, Fe—Ni—Mo alloy powder, Fe—Ni—Mo—Cu alloy powder, Fe—Co alloy powder, Fe—Ni—Co alloy powder, Fe—Cr alloy powder, Fe—Cr—Si alloy powder, Fe—Si—Cu—Nb alloy powder, Fe—Ni—Cr-based alloy powder and Fe—Cr—Al alloy powder. The metal magnetic powder may be amorphous or crystalline. For example, the magnetic metal powder may be a Fe—Si—B—Cr amorphous alloy powder, but an embodiment thereof is not limited thereto. Each of ferrite and metal magnetic powder particles may have an average diameter of about 0.1 μm to about 30 μm, but an embodiment thereof is not limited thereto. The body 110 may include two or more types of magnetic materials dispersed in resin. Here, the notion that the magnetic materials are of different types may indicate the magnetic materials dispersed in the resin may be distinguished from each other by one of an average diameter, a composition, crystallinity and a shape. Meanwhile, hereinafter, the magnetic material may be a metal magnetic powder, but an embodiment thereof is not limited only to the body 110 having a structure in which the metal magnetic powder is dispersed in an insulating resin. The insulating resin may include epoxy, polyimide, and liquid crystal polymer alone or in combination, but an embodiment thereof is not limited thereto.

The support member 120 may be disposed in the body 110 and may support the first and second coils 121 and 122, and may be formed as, for example, a polypropylene glycol (PPG) support member, a ferrite support member, or a metal-based soft magnetic support member. As illustrated, a through-hole H may be formed in a portion of the support member 120, specifically, a region corresponding to the cores C1 and C2 of the first and second coils 121 and 122, and a material forming the body 110 may be filled in the through-hole H.

As a specific example, the support member 120 may be formed of an insulating material including a thermosetting insulating resin such as epoxy resin, a thermoplastic insulating resin such as polyimide, or a photosensitive insulating resin, or an insulating material impregnated with reinforcing materials such as glass fibers or inorganic fillers in these insulating resins. More specifically, the support member 120 may be formed of an insulating material such as prepreg, Ajinomoto build-up film (ABF), FR-4, bismaleimide triazine (BT) resin, photoimagable dielectric (PID), but an embodiment thereof is not limited thereto. As an inorganic filler, at least one selected from a group consisting of silica (silicon dioxide, SiO₂), alumina (aluminum oxide, Al₂O₃), silicon carbide (SiC), barium sulfate (BaSO₄), talc, mud, mica powder, aluminum hydroxide (Al(OH)₃), hydroxide magnesium (Mg(OH)₂), calcium carbonate (CaCO₃), magnesium carbonate (MgCO₃), magnesium oxide (MgO), boron nitride (BN), aluminum borate (ALBO₃), barium titanate (BaTiO₃) and calcium zirconate (CaZrO₃) may be used. When the support member 120 is formed of an insulating material including a reinforcing material, the support member 120 may provide improved rigidity. When the support member 120 is formed of an insulating material not including glass fiber, it may be advantageous to reduce a thickness of the coil component 100 according to an embodiment. Also, with respect to the body 110 of the same size, the volume occupied by the coils 121 and 122 and/or the magnetic metal powder may be increased, such that component properties may be improved. When the support member 120 is formed of an insulating material photosensitive insulating resin, the number of processes for forming the coil 121 and 121 may be reduced, which is advantageous in reducing production costs, and conductive vias V1, V2, and V3 may be formed finely. The thickness of the support member 120 may be, for example, 10 μm or more and 50 μm or less, but an embodiment thereof is not limited thereto.

The first coil 121 may be disposed on one surface S1 of the support member 120 and may have a plurality of turns. Also, the second coil 122 may be disposed on the other surface S2 of the support member 120 and may have a plurality of turns. The coil component 100 may perform various functions in an electronic device through properties expressed from the first and second coils 121 and 122. For example, the coil component 100 may be a power inductor, and in this case, the first and second coils 121 and 122 may store electricity in the form of a magnetic field and may maintain an output voltage to stabilize power. The first and second coils 121 and 122 may be connected to each other by the plurality of conductive vias V1, V2, and V3, and to this end, the plurality of conductive vias V1, V2, and V3 may penetrate through the support member 120. The first and second coils 121 and 122 may be formed using a plating process, such as a pattern plating process, an anisotropic plating process, an isotropic plating process, and the like, and may be formed in a multilayer structure using a plurality of processes among the processes.

As for the method of connecting the first and second coils 121 and 122 to the plurality of conductive vias V1, V2, and V3, the plurality of conductive vias V1, V2, and V3 may connect the first coil 121 to the second coil 122, and for example, the plurality of conductive vias V1, V2, and V3 may connect the innermost turn 141 of the first coil 121 to the innermost turn 142 of the second coil 122. In this case, one V1 of the plurality of conductive vias V1, V2, and V3 may be connected to the other end E2 of the first coil 121, and the other V3 may be connected to the other end E2 of the second coil 122. One end E1 of the first coil 121 may correspond to a lead-out portion connected to the first external electrode 131, and the other end E2 may be present in the innermost turn 141. Similarly, in the second coil 122, one end E1 may correspond to a lead-out portion connected to the second external electrode 132, and the other end E2 may be present in the innermost turn 142.

As illustrated, the first coil 121 may include a plurality of first pads 161 connected to the plurality of conductive vias V1, V2, and V3 and a first connection portion 171 disposed therebetween, and a line width W1 of at least one of the plurality of first pads 161 is greater than a line width W2 of the first connection portion 171. In an embodiment, a structure in which the line width W1 of the entirety of the plurality of first pads 161 may be greater than the line width W2 of the first connection portion 171 is illustrated. As in an embodiment, when the first and second coils 121 and 122 are connected through a plurality of conductive vias V1, V2, and V3, a parallel connection structure may be implemented, and accordingly, electrical properties, specifically, R_{dc} properties may be improved (R_{dc} may decrease). Also, similarly to the first coil 121, the second coil 122 may include the plurality of second pads 162 connected to the plurality of conductive vias V1, V2, and V3 and a second connection portion 172 therebetween, and a line width W4 of at least one of the plurality of second pads 162 may be greater than a line width W5 of the second connection portion 172. In an embodiment, a structure in which the line width W4 of the entirety of the plurality of second pads 162 may be greater than the line width W5 of the second connection portion 172. As described above, the connection portions 171 and 172 having relatively narrow line widths W2 and W5 may be disposed at the innermost turns 141 and 142 of the first and second coils 121 and 122, and the sizes of the cores C1 and C2 may be sufficiently secured. In the embodiment, three conductive vias V1, V2, and V3 may be provided, and if desired, three or more conductive vias may be provided to improve electrical connectivity between the first and second coils 121 and 122.

In the first coil 121, the external turn 151 adjacent to the first connection portion 171 may have a line width greater than that of the first connection portion 171. That is, the condition of W3>W2 may be satisfied. Also, the external turn 151 adjacent to the plurality of first pads 161 in the first coil 121 may have a line width greater than those of the plurality of first pads 161 (W3>W1). Accordingly, the line width of the inner turn of the first coil 121 may be relatively narrow, and the sizes of cores C1 and C2 may be sufficiently secured. Similarly, the external turn 152 adjacent to the second connection portion 172 in the second coil 122 may have a line width greater than the second connection portion 172 (W6>W5). Also, the external turn 152 adjacent to the plurality of second pads 162 in the second coil 122 may have a greater line width than those of the plurality of second pads 162 (W6>W4).

The first and second external electrodes 131 and 132 may be formed externally on the body 110 and may be connected to one end E1 of the first and second coils 121 and 122, respectively. The first and second external electrodes 131 and 132 may be formed using a paste including a metal with excellent electrical conductivity, for example, a conductive paste including nickel (Ni), copper (Cu), tin (Sn), or silver (Ag) alone or an alloy thereof. Also, a plating layer may be further formed on the first and second external electrodes 131 and 132. In this case, the plating layer may include one or more selected from a group consisting of nickel (Ni), copper (Cu) and tin (Sn), for example, a nickel (Ni) layer and a tin (Sn) layer may be formed in order.

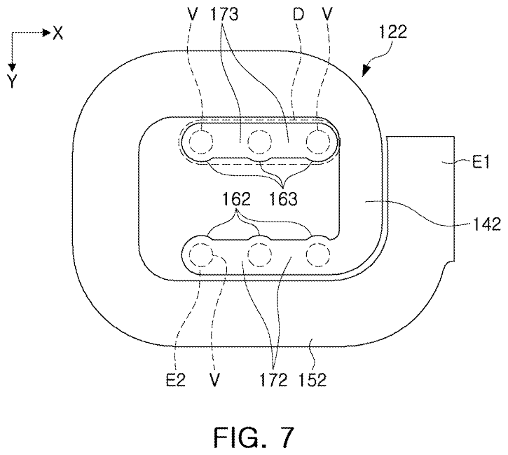

Modified embodiments will be described with reference to FIGS. 5 to 7. First, in the embodiment in FIGS. 5 and 6, the first coil 121 may include a plurality of first pad regions P1 respectively including a plurality of first pads 161 connected to a conductive via V and a first connection region C1 connecting the plurality of first pad regions P1 to each other. That is, the pads 161 may not be present only in one region, but may be disposed in the plurality of regions P1. In this case, the first connection region C1 may have a line width greater than those of the plurality of first pads 161 (WC1>W1), where the line width WC1 may be the length in the first direction (X-direction). Also, one of the plurality of first pad regions P1 may include the other end E2 of the first coil 121. Also, one of the plurality of first pads 161 may be connected to the first connection region C1. In FIG. 5, the plurality of first pad regions P1 may include the same number of first pads 161, or may include different numbers of first pads 161.

Similarly, the second coil 122 may include a plurality of second pad regions P2 respectively including a plurality of second pads 162 connected to a conductive via V and a second connection region C2 connecting the plurality of second pad regions P2 to each other. That is, the pads 162 may not be present only in one region, but may be disposed in the plurality of regions P2. In this case, the second connection region C2 may have a greater line width than the plurality of second pads 162 (WC2>W4), where the line width WC2 may be the length in the first direction (X-direction). Also, one of the plurality of second pad regions P2 may include the other end E2 of the second coil 122. Also, one of the plurality of second pads 162 may be connected to the second connection region C2. In FIG. 6, the plurality of second pad regions P2 may include the same number of second pad 162, or may include different numbers of second pad 162.

The line widths disclosed herein may be measured by optical microscopy and/or electron microscopy. Other methods and/or tools appreciated by one of ordinary skill in the art, even if not described in the present disclosure, may also be used.

In the embodiment in FIG. 7, the second coil 122 is illustrated and the first coil 121 may be the same as the example in FIG. 5. In the modified embodiment, a dummy pattern D spaced apart from the second coil 122 on the other surface of the support member 120 and connected to the first coil 121 through a plurality of conductive vias V may be further included. The dummy pattern D may also include a plurality of pads 163 and connection portions 173. Connectivity of the first and second coils 121 and 122 may be secured through the dummy pattern D, and as compared to the aforementioned embodiment, the number of turns of the second coil 122 may be reduced. Accordingly, inductance may be effectively controlled.

According to the aforementioned embodiments, a coil component having improved electrical properties may be obtained. Also, according to an embodiment, by securing a sufficient core size, a coil component having excellent properties and advantageous for miniaturization may be implemented.

While the embodiments have been illustrated and described above, it will be apparent to those skilled in the art that modifications and variations could be made without departing from the scope of the present disclosure as defined by the appended claims.

What is claimed is:

1. A coil component, comprising:
a body;
a support member disposed in the body;
a first coil disposed on one surface of the support member;
a second coil disposed on the other surface of the support member;
a plurality of conductive vias connecting the first coil to the second coil;
a first external electrode disposed on the body and connected to one end of the first coil; and
a second external electrode disposed on the body and connected to one end of the second coil,
wherein the first coil includes a plurality of first pads connected to the plurality of conductive vias and a first connection portion disposed between the plurality of first pads, and a line width of at least one of the plurality of first pads is greater than a line width of the first connection portion.

2. The coil component of claim 1, wherein, in the first coil, an external turn adjacent to the first connection portion has a line width greater than a line width of the first connection portion.

3. The coil component of claim 1, wherein an external turn adjacent to the plurality of first pads in the first coil has a line width greater than a line width of the plurality of first pads.

4. The coil component of claim 1, wherein the second coil includes a plurality of second pads connected to the plurality of conductive vias and a second connection portion disposed between the plurality of second pads, and a line width of at least one of the plurality of second pads is greater than a line width of the second connection portion.

5. The coil component of claim 4, wherein, in the second coil, an external turn adjacent to the second connection portion has a line width greater than a line width of the second connection portion.

6. The coil component of claim 4, wherein, in the second coil, an external turn adjacent to the plurality of second pads has a line width greater than a line width of the plurality of first pads.

7. The coil component of claim 1, wherein one of the plurality of conductive vias is connected to the other end of the first coil, and at least one other via among the plurality of conductive vias is connected to the other end of the second coil.

8. The coil component of claim 1, wherein the first coil includes: (i) a plurality of first pad regions respectively including a plurality of first pads, and (ii) a first connection region connecting the plurality of first pad regions to each other.

9. The coil component of claim 8, wherein the first connection region has a line width greater than a line width of the plurality of first pads.

10. The coil component of claim 8, wherein one of the plurality of first pad regions includes the other end of the first coil.

11. The coil component of claim 8, wherein one of the plurality of first pads is connected to the first connection region.

12. The coil component of claim 1, wherein the second coil includes: (i) a plurality of second pad regions respectively including a plurality of second pads, and (ii) a second connection region connecting the plurality of second pad regions to each other.

13. The coil component of claim 1, further comprising:
a dummy pattern disposed on the other surface of the support member, spaced apart from the second coil and connected to the first coil through the plurality of conductive vias.

14. The coil component of claim 1, wherein the plurality of conductive vias includes three or more conductive vias.

15. The coil component of claim 1, wherein the first coil has an innermost turn including: (i) a first end portion that includes the other end of the first coil, and (ii) a second end portion directly connected to an external turn of the first coil, wherein no pads are disposed on the second end portion.

16. The coil component of claim 15, wherein the innermost turn further includes a middle portion between the first and second end portions, and the first pads are disposed in the middle portion and the first end portion.

17. The coil component of claim 16, wherein the first pads in the middle portion face the first pads in the first end portion.

18. The coil component of claim 15, wherein the first pads are disposed only in the first end portion.
